(19) United States
(12) Patent Application Publication
(10) Pub. No.: US 2026/0070550 A1
(43) Pub. Date: Mar. 12, 2026

(54) METHOD OF A CONTROL SYSTEM FOR CONTROLLING A VEHICLE SPEED, A CONTROL SYSTEM, AND A VEHICLE COMPRISING THE CONTROL SYSTEM

(71) Applicant: Scania CV AB, Södertälje (SE)

(72) Inventors: Daniel Ståhl, Enköping (SE); Martin Berglund, Vagnhärad (SE); Jan Dellrud, Gnesta (SE); Frank Mohr, Värmdö (SE); Mikael Alenius, Segeltorp (SE); Henrik Sandstedt, Hägersten (SE)

(73) Assignee: Scania CV AB, Södertälje (SE)

(21) Appl. No.: 19/318,627

(22) Filed: Sep. 4, 2025

(30) Foreign Application Priority Data
Sep. 11, 2024 (SE) 2450897-0

(51) Int. Cl. B60W 30/14

(52) U.S. Cl. CPC B60W 30/143; B60W 2420/403; B60W 2420/408; B60W 2420/54; B60W 2552/30; B60W 2555/20

(57) ABSTRACT

A method of a control system for controlling a vehicle speed (v) of a vehicle is presented. The method comprises: controlling the vehicle speed (v) towards an adjusted reference speed (v_{ref_adj}) based on: a reference speed (v_{ref}) provided by a speed control system of the vehicle; and a visibility through at least one curve of a road ahead of the vehicle. Hereby, the risk for the driver deactivating the speed control system is reduced.

### TECHNICAL FIELD

The present invention relates to vehicle speed control and more specifically to a method for controlling a vehicle speed in a curve, to a control system configured for performing the speed control, and to a vehicle comprising the control system. The present invention also relates to a computer program and a computer-readable medium executing the method.

### BACKGROUND

The following background description constitutes a description of the background to the present invention, which does not, however, necessarily have to constitute prior art.

Vehicles of today are often equipped with a speed/cruise control system, which is configured to control the speed of the vehicle. The driver of the vehicle choses a set speed, and the speed/cruise control system then controls the vehicle speed based on this set speed and possibly also based on other parameters, such that a good fuel or energy economy, i.e. a low fuel or energy consumption, is provided for the vehicle.

There are today many types of speed/cruise control systems, in which various kinds of information/parameters are utilized as a basis for the control of the vehicle speed. Generally, the speed/cruise control systems of today are designed to provide a more fuel or energy efficient vehicle speed control than a driver would be able to provide by manually controlling the speed of the vehicle. The modern speed/cruise control systems may for example have access to additional information which is unknown to the driver, such as slope/inclination angles and/or information related to parameters not being visible for the driver, e.g. road properties behind crests or curves. Such additional information may be utilized for more efficiently controlling the vehicle speed.

### BRIEF DESCRIPTION OF THE INVENTION

When driving in curves with an activated speed/cruise control system, the resulting vehicle speed being the result of the speed/cruise control function may be too high for the driver to feel comfortable.

For example, if there is vegetation, buildings or infrastructure entities adjacent to the road at the curve, if there is a crest of the road in the curve, if there are other vehicles in front of the vehicle at the curve and/or if there is a poor weather condition at curve, the vehicle speed being provided by the speed/cruise control system might feel too high for the driver of the vehicle. Thus, the driver may be uncomfortable when travelling at the regulated vehicle speed. If the driver is uncomfortable at the regulated vehicle speed, a natural reaction would be to deactivate the speed/cruise control function, e.g. by braking the vehicle or by actively turning the speed/cruise control function off.

If the speed/cruise control function is deactivated, the fuel or energy consumption generally increases, since it is difficult for a driver to manually control the vehicle speed as efficiently as the speed/cruise control systems of today can control it. Also, by actively and unnecessary braking the vehicle, kinetic energy is almost always wasted.

It is therefore an objective of the present invention to provide a vehicle speed control such that these problems are at least partly solved.

According to a first aspect of the present invention, the objective is achieved through a method of a control system for controlling a vehicle speed v of a vehicle.

The method comprises:
controlling the vehicle speed v towards an adjusted reference speed v_{ref_adj} based on:
a reference speed v_{ref} provided by a speed control system of the vehicle; and
a visibility through at least one curve of a road ahead of the vehicle.

By taking the visibility through the at least one curve into consideration when determining the adjusted reference speed v_{ref_adj}, towards which the vehicle speed v is controlled, a possible discomfort of the driver when approaching the curve is also taken into account by the presented method. Hereby, the risk for the driver deactivating the speed control function/system in a curve, e.g. by pressing the brake pedal, is considerably reduced.

For example, if the end of the curve is obscured by e.g. an obstacle at or close to the road of the curve, the driver might feel that the vehicle speed normally controlled by the speed control system is too high. This may cause discomfort or even anxiety for the driver of the vehicle. There is therefore a risk that the driver manually deactivates the speed control function/system due to the experienced discomfort. As mentioned above, a manually controlled vehicle speed often results in an increased fuel or energy consumption, since it is almost impossible for a driver to manually regulate the vehicle speed as efficiently as modern speed control systems do. Also, if the driver actively brakes the vehicle, kinetic energy is wasted by the braking.

The herein presented vehicle speed control may for example reduce if the visibility in the curve is poor. Also, the the herein presented vehicle speed control may be utilized for creating increased safety margins, e.g. by an early reduction of the vehicle speed before the vehicle enters the curve, if the visibility in the curve is poor.

Hereby, the herein presented vehicle speed control, which also takes curve visibility into account, improves the driver comfort and thereby reduces the risk for deactivation of the speed control function/system.

Also, if there is good visibility through the curve, the vehicle speed may be kept high, such that the driver does not override the speed control function/system by pressing the accelerator pedal of the vehicle.

Hereby, an overall reduced, or at least non-increased, fuel or energy consumption is provided for the curved road section.

According to an embodiment, the method further comprises:
receiving the reference speed v_{ref} from the speed control system;
determining the adjusted reference speed v_{ref_adj} based on:
the received reference speed v_{ref}; and
the visibility through the at least one curve of the road ahead of the vehicle.

Hereby, the visibility through the at least one curve is efficiently taken into consideration when determining the adjusted reference speed v_{ref_adj}, towards which the vehicle speed v is controlled. To adjust the reference speed v_{ref} provided by the speed control system like this is a low complex approach to improve the comfort of the driver when travelling through curves.

According to an embodiment, the control of the vehicle speed v towards the adjusted reference speed v_{ref_adj} reduces the vehicle speed v below the reference speed v_{ref} if the visibility in the at least one curve is at least partly restricted.

Hereby, the driver feels safe and comfortable, since the vehicle speed is controlled in a way similar to how the driver would manually control the speed in this situation. The driver will therefore continue to let the speed control function/system control the vehicle speed.

According to an embodiment, the speed control system is one in the group of:
a curve speed cruise control system;
a one pedal drive system;
an adaptive one pedal drive system;
a cruise control system;
an adaptive cruise control system;
an active prediction cruise control system;
a cruise control system obtaining a speed demand from an offboard entity; and
a cruise control system utilizing traffic sign recognition.

Thus, the herein presented control of the vehicle speed may be combined with essentially any existing speed control system today, resulting in a flexible implementation.

According to an embodiment, the method comprises:
determining the visibility through the at least one curve based on information provided by one or more onboard sensors.

Information provided by one or more onboard sensors is always available in the vehicle, also if there is no communication system coverage at the position where the vehicle is travelling, such as e.g. at the countryside, in remote woods or in tunnels.

According to an embodiment, the one or more onboard sensors comprise at least one in the group of:
a camera;
a radar system;
a sonar system;
a lidar system;
a visibility sensor; and
a precipitation sensor.

Thus, the herein presented control of the vehicle speed may be performed based on information provided by a large number of onboard sensors, and may therefore be implemented in essentially any vehicle of today.

According to an embodiment, the method comprises:
determining the visibility through the at least one curve based on map data.

Detailed map data is today available for large parts of the road network. The map data is very accurate and may be periodically updated such that it is up to date.

Together with positioning information, such as e.g. global positioning system (GPS) information, for example characteristics of slopes, curves and buildings in or at the curves may be accurately and efficiently detected/determined.

According to an embodiment, the method comprises:
determining the visibility through the at least one curve based on vehicle-to-everything information.

By utilizing vehicle-to-everything information, determinations and/or observations made by e.g. other vehicles and/or systems may be taken advantage of. For example, if a visibility though a curve has already been determined by another vehicle having travelled through the curve at an earlier time instant, this determined visibility may be transmitted to, and utilized by, the vehicle when it subsequently travels through the curve.

According to an embodiment, the adjusted reference speed v_{ref_adj} is determined based also on a lateral road inclination of the at least one curve.

The adjusted reference speed v_{ref_adj} is here determined based on a combination of at least the visibility and the lateral road inclination of the curve, which results in a determination of the adjusted reference speed v_{ref_adj}, and thus also in a control of the vehicle speed, being even more similar to how the driver would control the vehicle himself. The risk for deactivation of the vehicle speed control is therefore further reduced.

According to an embodiment, the adjusted reference speed v_{ref_adj} is determined based also on a longitudinal road inclination of the at least one curve.

The adjusted reference speed v_{ref_adj} is here determined based on a combination of at least the visibility and the longitudinal road inclination of the curve, which results in a control of the vehicle speed being similar to how the driver would control the vehicle himself in a sloped curve. The risk for deactivation of the vehicle speed control is therefore further reduced.

According to an embodiment, the adjusted reference speed v_{ref_adj} is determined based also on a road friction of the at least one curve.

The adjusted reference speed v_{ref_adj} is here determined based on a combination of at least the visibility and the road friction in the curve, which results in a control of the vehicle speed being similar to how the driver would control the vehicle himself e.g. on icy roads. The risk for deactivation of the vehicle speed control is therefore further reduced.

According to an embodiment, the adjusted reference speed v_{ref_adj} is determined based also on a usable road width of the at least one curve.

The adjusted reference speed v_{ref_adj} is here determined based on a combination of at least the visibility and the usable road width in the curve, which results in a control of the vehicle speed being similar to how the driver would control the vehicle himself e.g. when the road is narrow in the curve. The risk for deactivation of the vehicle speed control is therefore further reduced.

According to an embodiment, the adjusted reference speed v_{ref_adj} is determined based also on characteristics of at least one off-road area adjacent to the at least one curve.

The adjusted reference speed v_{ref_adj} is here determined based on a combination of at least the visibility and the off-road area adjacent to the curve, which results in a control of the vehicle speed being similar to how the driver would control the vehicle himself e.g. when there are steep cliffs next to the road. The risk for deactivation of the vehicle speed control is therefore further reduced.

According to an embodiment, the adjusted reference speed v_{ref_adj} is determined based also on a center of gravity of the vehicle.

The adjusted reference speed v_{ref_adj} is here determined based on a combination of at least the visibility and center of gravity of the vehicle, which results in a control of the vehicle speed being similar to how the driver would control the vehicle himself e.g. when vehicle platform is fully loaded. The risk for deactivation of the vehicle speed control is therefore further reduced.

According to a second aspect of the present invention, the objective is achieved through a control system configured to control a vehicle speed v of a vehicle, wherein the control system is configured to:
control the vehicle speed v towards an adjusted reference speed v_{ref_adj} based on:
a reference speed v_{ref} provided by a speed control system of the vehicle; and
a visibility through at least one curve of a road ahead of the vehicle.

The control system has corresponding advantages as mentioned for the method according to the first aspect.

According to a third aspect of the present invention, the objective is achieved through a vehicle comprising a herein described control system.

The vehicle has corresponding advantages as mentioned for the method according to the first aspect.

According to a fourth aspect, the invention relates to a computer program comprising instructions which, when the program is executed by a computer, cause the computer to carry out the herein described methods.

The computer program has corresponding advantages as mentioned for the method according to the first aspect.

According to a fifth eleventh, the invention relates to a computer-readable medium comprising instructions which, when executed by a computer, cause the computer to carry out the herein described methods.

The computer-readable medium has corresponding advantages as mentioned for the method according to the first aspect.

It will be appreciated that all the embodiments described for the method aspects of the invention are applicable also to one or more of the control system aspect, the vehicle aspect, the computer program aspect and the computer-readable medium aspect of the invention. Thus, all the embodiments described for the method aspects of the invention may be performed/implemented by the herein described control system, vehicle, computer program and/or the computer-readable medium. The control system may also be a processing device, i.e. a device. The control system aspect, the vehicle aspect, the computer program aspect and the computer-readable medium aspect, and their embodiments, have advantages corresponding to the advantages mentioned above for the methods and their embodiments.

### BRIEF LIST OF FIGURES

Embodiments of the invention will be illustrated in more detail below, along with the enclosed drawings, where similar references are used for similar parts, and where:

FIG. 1 schematically illustrates an example vehicle, in which aspects and/or embodiments of the present invention may be implemented,

FIG. 2 shows a flow chart diagram for a method of a control system for controlling a vehicle speed v of a vehicle according to some aspects and/or embodiments of the present the invention,

FIGS. 3a-b schematically illustrates some non-limiting driving examples at which herein presented aspects and/or embodiments of the present the invention may be utilized, and

FIG. 4 schematically illustrates a control unit according to various embodiments of the present invention.

### DESCRIPTION OF PREFERRED EMBODIMENTS

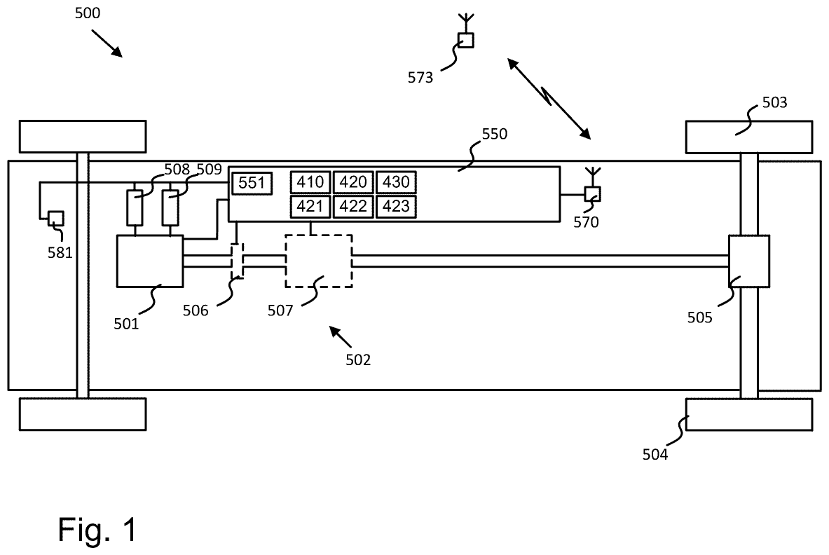

FIG. 1 schematically shows an exemplary heavy vehicle 500. This example vehicle 500 will be used to explain the herein presented solution and its aspects and embodiments. The aspects and embodiments are, however, not limited to use in vehicles as the ones shown in FIG. 1, but may also be used in essentially any other type of vehicle.

The vehicle 500 comprises multiple wheels, of which at least one pair of drive wheels 503, 504. The truck 500 furthermore comprises at least one powertrain 502 configured to transfer a torque between at least one power source 501, such as e.g. a combustion engine, at least one electric machine, or a combination of a combustion engine and at least one electric machine, implementing a so-called hybrid drive, to the at least one pair of drive wheels 503, 504. The combustion engine is provided with fuel from a fuel tank 508. The at least one electric machine is provided with electrical energy from at least one voltage energy storage 509, e.g. a battery pack, coupled to the at least one electric machine.

The powertrain 502, and its components, is controlled by at least one control unit/device/system 550. The at least one second energy storage 509 may also be controlled by a control unit/device/system 550.

The torque provided by the at least one power source 501 may be provided to the at least one pair of drive wheels 503, 504 via a central gear 505, such as e.g. a customary differential, and drive shafts connected with the central gear. One or more electric machines may also be arranged essentially anywhere in the vehicle 500, as long as the produced torque is provided to the drive wheels 503, 504, e.g. adjacent to one or more of the drive wheels 503, 504, as is understood by a skilled person.

The vehicle 500 may be braked by utilizing the at least one power source 501, i.e. by utilizing regenerative braking or motor braking. The vehicle 500 may further include at least one braking arrangement arranged at each one of the wheels of the vehicle, where the at least one braking arrangement may be included in a braking system. If the at least one power source 501 comprises a combustion engine, the powertrain 502 of the vehicle 500 may comprise a clutch 506 and a gearbox 507 for providing the torque to the central gear 505. However, if the at least one power source 501 does not comprise a combustion engine, the clutch 506, and possibly also the gearbox 507, may be omitted in the powertrain 502 of the vehicle 500.

The power source 501, is controlled by a speed/cruise control system 551, which may be comprised/implemented in the control unit/device/system 550 of the vehicle 500, such that the vehicle speed v of the vehicle 500 is controlled.

In FIG. 1, only the units/devices/entities of the vehicle being useful for understanding the present invention are schematically illustrated. Not all illustrated components have to be comprised in the vehicle, depending on the implementation of the present invention. Further, the control unit/device/system 550 is in FIG. 1 illustrated as one single unit/device/system. However, as is understood by a skilled person, the control unit/device/system 550 may be implemented by utilization of essentially any number of units/devices/systems.

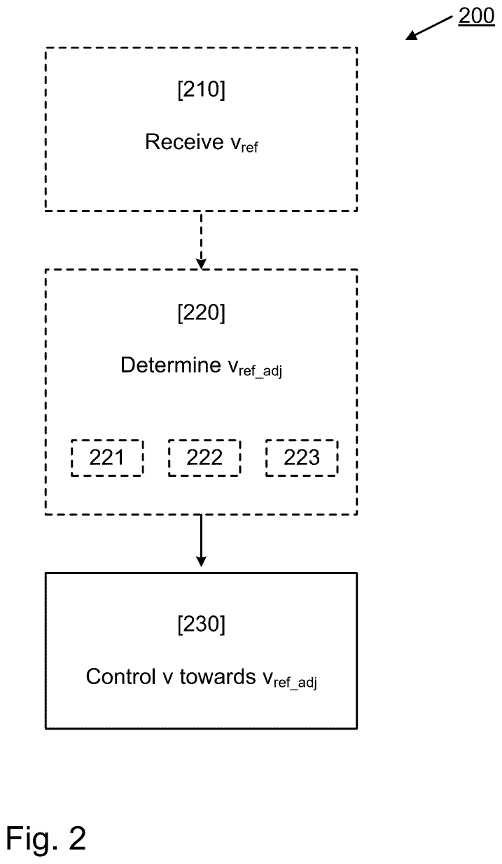

FIG. 2 shows a flow chart diagram for a method 200 for controlling a vehicle speed v of a vehicle 500 according to some aspects and/or embodiments.

The method 200 comprises the step 230 of the vehicle speed v towards an adjusted reference speed v_{ref_adj} based on a reference speed v_{ref} provided by a speed control system 551 of the vehicle 500 and a visibility through at least one curve 620 of a road ahead of the vehicle 500.

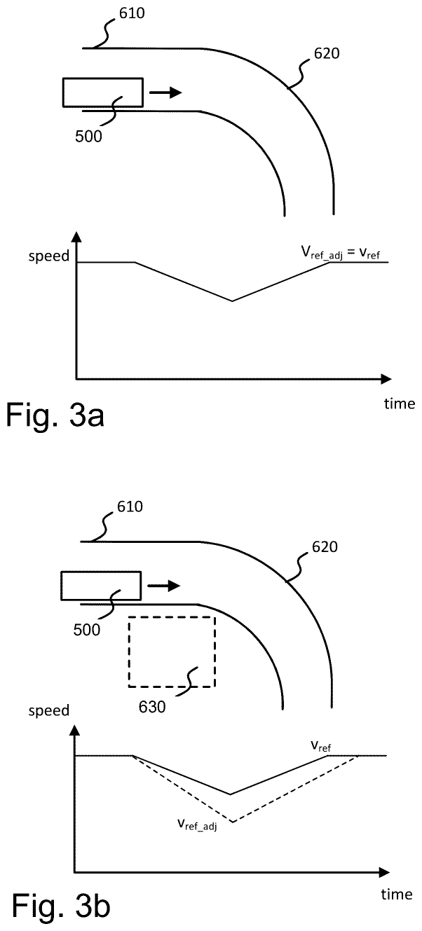

FIGS. 3a-b schematically show two driving examples illustrating the method 200 for controlling the vehicle speed v of a vehicle 500 according to some aspects and/or embodiments.

FIG. 3a schematically illustrates a vehicle 500 driving on a road comprising a first straight road section 610 followed by a curved road section 620 with good visibility through the curve. In the speed diagram, the solid line reference speed v_{ref} being provided by the speed control system 551 of the vehicle 500 has an initial value, for example corresponding to a set speed vₛₑₜ chosen by the driver, which is reduced in the curve, and is then raised again after the curve 620, for example to its initial value. Since the visibility through the curve is good, the adjusted reference speed v_{ref_adj} will here be equal to the reference speed v_{ref}. The vehicle 500 is here controlled 230 towards the adjusted reference speed v_{ref_adj}, and will result in a vehicle speed v being essentially equal to the solid line reference speed v_{ref}.

In FIG. 3b, however, when the vehicle 500 is travelling on the same road, comprising the straight road section 610 and the following curved road section 620, some kind of obstacle 630 has appeared adjacent to the road in the curve. Thus, the visibility in the curve 620 is affected/restricted/obscured by some kind of obstacle 630, such as for example vegetation adjacent to the curve 620, at least one building adjacent to the curve 620, a crest or hill hiding at least a part of the curve 620, and/or at least one infrastructure entity adjacent to the curve 620. According to the herein presented method 200, the vehicle speed v will here be controlled 230 towards the adjusted reference speed Vref_adj, illustrated with dashed lines, which differs from the reference speed Vref, illustrated with solid lines. The vehicle speed v will here thus essentially correspond to the dashed line adjusted reference speed Vref_adj, and will be reduced more than the reference speed v_{ref} in the curve 620 due to the obstacle 630 affecting the visibility through the curve 620. Thus, due to the restricted visibility, the vehicle speed v is reduced to the dashed line adjusted reference speed v_{ref_adj} when the obstacle 630 is present in FIG. 3b, which is lower than for the example shown in FIG. 3a without the obstacle 630. When the vehicle 500 has passed the obstacle 630, the vehicle speed v may be controlled to increase towards the reference speed v_{ref} again, i.e. to the reference speed v_{ref} taking the curvature but not the visibility through the curve into consideration. The acceleration of the vehicle speed v towards the reference speed v_{ref} may then be more or less aggressively performed.

Thus, according to an embodiment, the vehicle speed v is controlled 230 towards the adjusted reference speed v_{ref_adj}, which reduces the vehicle speed v below the reference speed v_{ref} if the visibility in the at least one curve is at least partly restricted. In other words, the adjusted reference speed v_{ref_adj} is reduced to a value being below/lower than the reference speed v_{ref} in the curve 620 if the visibility in the curve 620 is at least partly restricted, as illustrated in FIG. 3b.

It should be noted that conventional speed control systems would control the vehicle speed towards the reference speed v_{ref} also in the example of FIG. 3b, since they do not take the visibility of the curve 620 into consideration in the speed control. The herein presented speed control thus results in a further reduced vehicle speed v in the curve 620, if the visibility is at least partly restricted in the curve, hereby improving the driver comfort and/or safety when travelling through a curve without knowing what will happen in the end of and/or after the curve.

In the example of FIG. 3b, the visibility in the curve is affected by an obstacle in the curve. However, the visibility may also be affected for example by a crest of the road in the curve 620, at least one other vehicle in front of the vehicle 500 and/or a weather condition at the curve 620, such as rain, snow, fog, or some other weather condition impairing the visibility.

According to an embodiment, illustrated in FIG. 2, the method 200 further comprises the step 210 of receiving the reference speed v_{ref} from the speed control system 551 of the vehicle 500.

Thereafter, the method 200 further comprises the step 220 of determining the adjusted reference speed v_{ref_adj} based on the received reference speed v_{ref} and the visibility through the at least one curve 620 of the road ahead of the vehicle 500.

The hereby determined adjusted reference speed v_{ref_adj} is then used as a basis for the control 230 of the vehicle speed v. Thus, the vehicle speed v is controlled 230 towards the adjusted reference speed v_{ref_adj}.

The method steps of FIG. 2 may be performed in another order than illustrated in FIG. 2, as long as the information needed for performing a method step is available when the step is to be performed.

According to an embodiment, the speed control system 551 providing the reference speed v_{ref} is any suitable, possibly conventional, speed control system, such as for example a curve speed cruise control system, a one pedal drive system, an adaptive one pedal drive system, a cruise control system of some kind, an adaptive cruise control system, an active prediction cruise control system, a cruise control system obtaining a speed demand from an offboard entity and/or a cruise control system utilizing traffic sign recognition. The herein presented method may be combined with essentially any speed control system providing a reference speed v_{ref} towards which a vehicle speed should be controlled. The herein presented method then adjusts this provided reference speed v_{ref} such that curve visibility is taken into consideration in the control 230 of the vehicle speed v in the curve 620.

According to an embodiment, the visibility through the curve 620 is determined 221 based on information provided by one or more onboard sensors 581. Such onboard sensors 581 may comprise, or be comprised in, any suitable sensor or system providing an indication associated with the curve visibility, for example a camera, a radar system, a sonar system, a lidar system, a visibility sensor of some kind, and/or a precipitation sensor, configured for sensing e.g. rain or snow.

According to an embodiment, the visibility through the curve 620 is determined 222 based on map data. Detailed map data may have information associated with buildings and/or infrastructure entities adjacent to the curve 620, and/or may have information associated with a crest of the road in the curve 620. Such information from the map data may be utilized for determining 222 the visibility in the curve 620, and may thus be used as basis for determining 220 the adjusted reference speed v_{ref_adj}.

According to an embodiment, the visibility through the curve 620 is determined 223 based on vehicle-to-everything (V2X) information. The vehicle-to-everything information may comprise information associated with visibility determinations for a curve having been performed by other vehicles. Other vehicles and/or other off board entities, e.g. entities comprising traffic information cameras, commonly denoted as 573 in FIG. 1, may also report if new buildings or other obstacles have occurred along at the curve that affect the visibility, if the vegetation has changed at the curve such that the visibility is affected, if there is roadwork/repairs that affect the visibility, or if there is a weather condition affecting the visibility at the curve.

According to an embodiment, the adjusted reference speed v_{ref_adj} is determined 220 based also on, i.e. in addition to at least the visibility, a lateral road inclination of the at least one curve 620. For example, the adjusted reference speed v_{ref_adj} may be reduced at higher lateral road inclinations, especially directed outwards in the curve 620. Information associated with the lateral road inclination may be provided by one or more onboard sensors 581, by map data and/or by vehicle-to-everything communication 573.

According to an embodiment, the adjusted reference speed v_{ref_adj} is determined 220 based also on, i.e. in addition to at least the visibility, a longitudinal road inclination of the at least one curve 620. For example, the adjusted reference speed v_{ref_adj} may be reduced at higher longitudinal road inclinations, which may be interpreted as an indication of a crest in or before the curve 620. Information associated with the longitudinal road inclination may be provided by one or more onboard sensors 581, by map data and/or by vehicle-to-everything communication 573.

According to an embodiment, the adjusted reference speed v_{ref_adj} is determined 220 based also on, i.e. in addition to at least the visibility, a road friction of the at least one curve 620. For example, the adjusted reference speed v_{ref_adj} may be reduced at affected/lower road friction, e.g. due to ice and/or snow on the road surface.

Information associated with the road friction may be provided by one or more onboard sensors 581, by map data and/or by vehicle-to-everything communication 573.

According to an embodiment, the adjusted reference speed v_{ref_adj} is determined 220 based also on, i.e. in addition to at least the visibility, a usable road width of the at least one curve 620. The usable road width Wur here comprises a drivable road width W_{dr} of the curve 620 minus an unusable road width Wᵤᵤ of the curve 620; Wᵤᵣ=W_{dr}−Wᵤᵤ. The unusable road width Wᵤᵤ may e.g. be occupied by at least one other oncoming vehicle traveling in the curve 620 in a direction opposite to the vehicle 500, at least one stationary vehicle on the road in the curve 620, at least one obstacle on the road in the curve 620, at least one person on the road in the curve 620, at least one object on the road in the curve 620, and/or a safety zones around such vehicles, obstacles, persons and objects on or adjacent adjacent to the road in the curve. For example, the adjusted reference speed v_{ref_adj} may be reduced at a small and/or reduced usable road width Wᵤᵣ. Information associated with the usable road width Wᵤᵣ may be provided by one or more onboard sensors 581, by map data and/or by vehicle-to-everything communication 573.

According to an embodiment, the adjusted reference speed v_{ref_adj} is determined 220 based also on, i.e. in addition to at least the visibility, characteristics of at least one off-road area adjacent to the at least one curve 620. The off-road area may here comprise the landscape outside the road. For example, the adjusted reference speed v_{ref_adj} may be reduced if there are steep cliffs next to the curve 620, such as for serpentine roads, compared to if there are flat fields next to the road. Information associated with the off-road area may be provided by one or more onboard sensors 581, by map data and/or by vehicle-to-everything communication 573.

According to an embodiment, the adjusted reference speed v_{ref_adj} is determined 220 based also on, i.e. in addition to at least the visibility, a center of gravity of the vehicle 500. For example, the adjusted reference speed v_{ref_adj} may be reduced by if the center of gravity of the vehicle is on a higher vertical level than normal, such as when heavy high loads are packed in a cabinet or on a loading platform of the vehicle 500. Information associated with the center of gravity be provided by one or more onboard sensors 581, by vehicle-to-everything communication 573, by the driver and/or by personnel loading the vehicle 500.

According to an aspect, a control system 550 configured to control a vehicle speed v of a vehicle 500 is presented. the control system 550 is configured to control 230 the vehicle speed v towards an adjusted reference speed v_{ref_adj}, as herein described, i.e. based on a reference speed v_{ref} provided by a speed control system 551 of the vehicle 550 and a visibility through at least one curve 620 of a road ahead of the vehicle 500.

According to various embodiments, the control system 550 is configured to determine 220 the adjusted reference speed v_{ref_adj} based also on further additional parameters, as herein described. The control system 550 is thus configured for performing the herein described method 200, i.e. to perform the herein described aspects and embodiments.

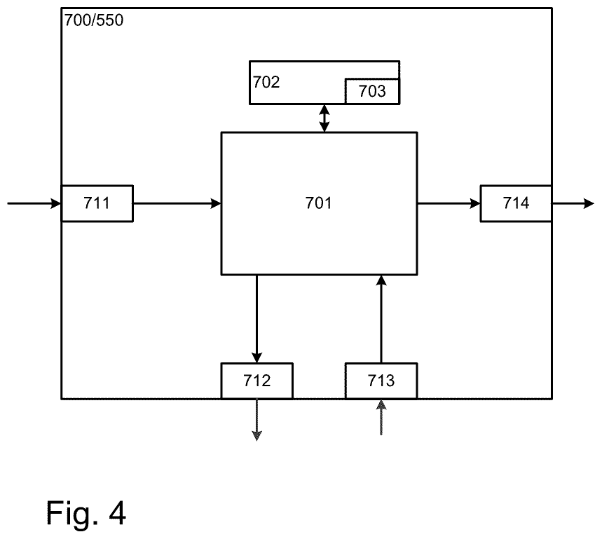

FIG. 4 shows in schematic representation a control unit 700/550. The control unit 700/550 comprises a computing unit 701, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 701 is connected to a memory unit 702 arranged in the control unit 700/550, which memory unit provides the computing unit 701 with, for example, the stored program code and/or the stored data which the computing unit 701 requires to be able to perform computations. The computing unit 701 is also arranged to store partial or final results of computations in the memory unit 702.

In addition, the control unit 700/550 is provided with devices 711, 712, 713, 714 for receiving and transmitting input and output signals. These input and output signals can contain waveforms, impulses, or other attributes which, by the devices 711, 713 for the reception of input signals, can be detected as information and can be converted into signals which can be processed by the computing unit 701. These signals are then made available to the computing unit 701. The devices 712, 714 for the transmission of output signals are arranged to convert signals received from the computing unit 701 in order to create output signals by, for example, modulating the signals, which can be transmitted to other parts of and/or systems in the vehicle.

Each of the connections to the devices for receiving and transmitting input and output signals can be constituted by one or more of a cable; a data bus, such as a CAN bus (Controller Area Network bus), a MOST bus (Media Orientated Systems Transport bus), or some other bus configuration; an ethernet connection; or by a suitable wireless connection. A person skilled in the art will appreciate that the above-stated computer can be constituted by the computing unit 701 and that the above-stated memory can be constituted by the memory unit 702.

Control systems in modern vehicles commonly comprise communication bus systems consisting of one or more communication buses for linking a number of electronic control units (ECU's), or controllers, and various components located on the vehicle. Such a control system can comprise a large number of control units and the responsibility for a specific function can be divided amongst more than one control unit. Vehicles of the shown type thus often comprise significantly more control units than are shown in FIGS. 1 and 5, which is well known to the person skilled in the art within this technical field.

In a shown embodiment, the present invention may be implemented by the one or more herein mentioned control units or processing arrangements 700/550. The invention can also, however, be implemented wholly or partially in one or more other control units already present in the vehicle, or in some control unit dedicated to the present invention.

Here and in this document, control units, control entities or processing arrangements are sometimes described as being arranged for performing the methods and/or steps 210, 220, 230, 221, 222, 223 according to the invention. This also includes that the units, entities or processing arrangements are designed to and/or configured to perform these method steps.

One or more control entities 410, 420, 430, 421, 422, 423 may be arranged for performing the methods and/or steps. Such entities 410, 420, 430, 421, 422, 423 may be arranged as separate entities, or may be logically separated but physically implemented in the same unit, or may be both logically and physically arranged together. These control entities 410, 420, 430, 421, 422, 423 may for example correspond to groups of instructions, which can be in the form of programming code, that are input into, and are utilized by a processor/computing unit 701 when the entities are active and/or are utilized for performing its method steps, respectively.

The present invention is not limited to the above described embodiments. Instead, the present invention relates to, and encompasses all different embodiments being included within the scope of the independent claims.

1. A method of a control system for controlling a vehicle speed (v) of a vehicle, the method comprising:
controlling the vehicle speed (v) towards an adjusted reference speed (v_{ref_adj}) based on:
a reference speed (v_{ref}) provided by a speed control system of the vehicle; and
a visibility through at least one curve of a road ahead of the vehicle.

2. The method as claimed in claim 1, the method further comprising:
receiving the reference speed (v_{ref}) from the speed control system
determining the adjusted reference speed (v_{ref_adj}) based on:
the received reference speed (v_{ref}); and
the visibility through the at least one curve of the road ahead of the vehicle.

3. The method as claimed in claim 1, wherein the control of the vehicle speed (v) towards the adjusted reference speed (v_{ref_adj}) reduces the vehicle speed (v) below the reference speed (v_{ref}) if the visibility through the at least one curve is at least partly restricted.

4. The method as claimed in claim 1, wherein the speed control system is one in the group of:
a curve speed cruise control system;
a one pedal drive system;
an adaptive one pedal drive system;
a cruise control system;
an adaptive cruise control system;
an active prediction cruise control system;
a cruise control system obtaining a speed demand from an offboard entity; and
a cruise control system utilizing traffic sign recognition.

5. The method claimed in claim 1, wherein the method comprises:
determining the visibility through the at least one curve based on information provided by one or more onboard sensors

6. The method as claimed in claim 5, wherein the one or more onboard sensors comprise at least one in the group of:
a camera;
a radar system;
a sonar system;
a lidar system;
a visibility sensor; and
a precipitation sensor.

7. The method as claimed in claim 1, wherein the method comprises:
determining the visibility through the at least one curve based on map data.

8. The method as claimed in claim 1, wherein the method comprises:
determining the visibility through the at least one curve based on vehicle-to-everything information.

9. The method as claimed in claim 2, wherein the adjusted reference speed (v_{ref_adj}) is determined based also on a lateral road inclination of the at least one curve

10. The method as claimed in claim 2, wherein the adjusted reference speed (v_{ref_adj}) is determined based also on a longitudinal road inclination of the at least one curve.

11. The method as claimed in claim 2, wherein the adjusted reference speed (v_{ref_adj}) is determined based also on a road friction of the at least one curve

12. The method as claimed in claim wherein the adjusted reference speed (v_{ref_adj}) is determined based also on a usable road width of the at least one curve.

13. The method as claimed in claim 2, wherein the adjusted reference speed (v_{ref_adj}) is determined based also on characteristics of at least one off-road area adjacent to the at least one curve.

14. The method as claimed in claim 2, wherein the adjusted reference speed (v_{ref_adj}) is determined based also on a center of gravity of the vehicle.

15. A computer program product used with a control system for controlling a vehicle speed (v) of a vehicle, wherein said computer program product comprising computer instructions to cause a computer to perform the following operations:
controlling the vehicle speed (v) towards an adjusted reference speed (v_{ref_adj}) based on:
a reference speed (v_{ref}) provided by a speed control system of the vehicle; and
a visibility through at least one curve of a road ahead of the vehicle.

16. (canceled)

17. A control system configured to control a vehicle speed (v) of a vehicle, wherein the control system is configured to:
control the vehicle speed (v) towards an adjusted reference speed (v_{ref_adj}) based on:
a reference speed (v_{ref}) provided by a speed control system of the vehicle and
a visibility through at least one curve of a road ahead of the vehicle.

18. A vehicle comprising a control system configured to control a vehicle speed (v) of a vehicle, wherein the control system is configured to:
control the vehicle speed (v) towards an adjusted reference speed (v_{ref_adj}) based on:
a reference speed (v_{ref}) provided by a speed control system of the vehicle; and
a visibility through at least one curve of a road ahead of the vehicle.
